(19) United States
(12) Patent Application Publication
(10) Pub. No.: US 2013/0278384 A1
(43) Pub. Date: Oct. 24, 2013

(54) APPLIANCE, DEVICE, AND SYSTEM FOR HOME ENERGY MANAGEMENT

(71) Applicants: Irena Jozic MCDOWELL, Louisville, KY (US); Chad Michael HELMS, Louisville, KY (US)

(72) Inventors: Irena Jozic MCDOWELL, Louisville, KY (US); Chad Michael HELMS, Louisville, KY (US)

(21) Appl. No.: 13/452,866

(22) Filed: Apr. 21, 2012

(51) Int. Cl. G08B 3/10; G08B 1/08

(52) U.S. Cl. 340/6.1

(57) ABSTRACT

A home energy management system is configured to alert a homeowner based on information from an appliance. In one embodiment, the system comprises an appliance and an apparatus that communicates, e.g., via wireless technology. The appliance comprises circuitry to generate a data packet, which comprises information to identify the appliance as well as the status of one or more features and functions of the appliance. Exemplary functions can monitor movement proximate the appliance and/or entry or access to the interior of the appliance. The remote apparatus receives the data packet and, in one example, generates an output to an end user that conveys information in the data packet to the end user. The output can comprise an electronic message (e.g., an email or text message) that identifies from the data packet one or more appliance functions that exhibit a change in status.

### BACKGROUND

1. Technical Field

The subject matter of the present disclosure relates to energy management and energy management systems for a household and, more particularly, to features of energy management systems that communicate information to an end user.

2. Description of Related Art

Home owners and other consumers of electrical power desire efficient energy management systems that can help reduce costs and peak demand to provide more efficient energy use. Various measures have been developed to address energy management goals. For example, energy efficient devices and appliances enable consumers to reduce energy consumption. In addition, utilities provide some consumers with direct control for certain electrical loads, such as heating or cooling devices, pool pumps, and so on, to allow utilities to control energy and power usage. Also, some utilities implement demand response programs for residential as well as industrial consumers in order to provide reduced peak demand requirements and to effectively manage energy consumption. While these and other developments are available and enable consumers to manage power consumption, intelligent systems that monitor and manage the devices in the household and the household in general as well as that effectively communicate information to the consumer are still being developed.

### BRIEF DESCRIPTION OF THE INVENTION

The present disclosure describes subject matter that takes advantage of features, functions, and services not readily available and/or leveraged on household appliances. Implementing one or more of the methods below integrates these unleveraged items with facets of the energy management system (and associated energy management theory). Wireless networking of these systems, for example, provides a platform that allows a home owner ready access to information and data about the household appliance and, in some cases, about the household in general. Systems that utilize the appliances and the devices below can update the homeowner who leaves on vacation or is gone for an extended period of time on the status of the household in case of fire, burglary, or other unfortunate emergency.

### BRIEF DESCRIPTION OF THE DRAWINGS

Reference is now made briefly to the accompanying drawings, in which:

FIG. 1 depicts a schematic diagram of an exemplary embodiment of an energy management system;

FIG. 2 depicts a flow diagram of a method for generating an output on an appliance in the energy management system of FIG. 1;

FIG. 3 depicts a flow diagram of a method for generating an output on a remote apparatus in the energy management system of FIG. 1; and

FIG. 4 depicts a high-level wiring schematic of another exemplary embodiment of an energy management system.

Where applicable like reference characters designate identical or corresponding components and units throughout the several views, which are not to scale unless otherwise indicated.

### DETAILED DESCRIPTION OF THE INVENTION

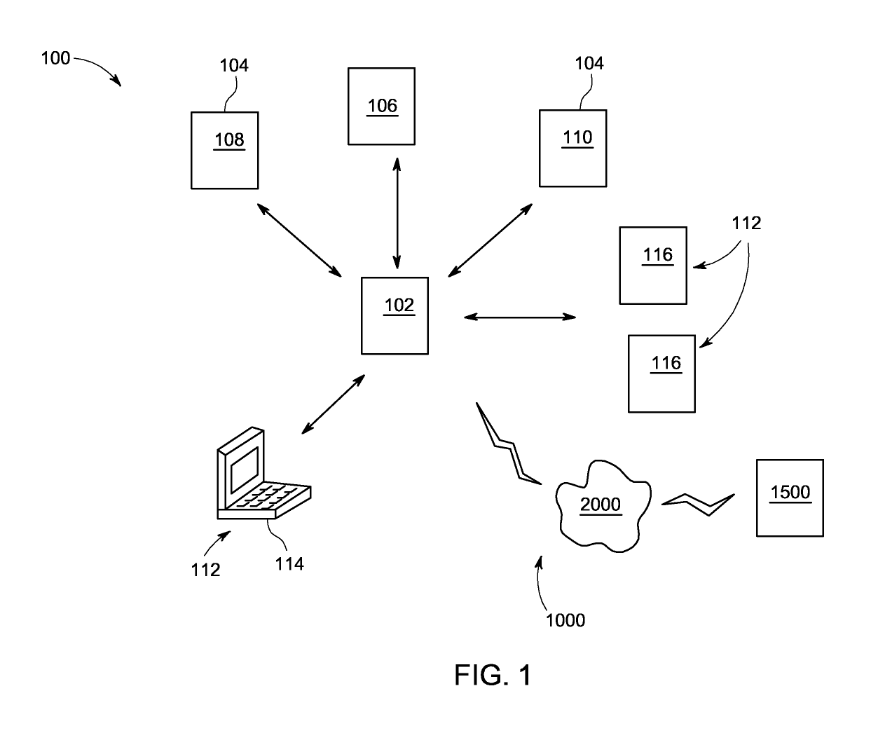

Referring now to the drawings, FIG. 1 illustrates a management system 100 with an apparatus 102 that communicates with, either directly or indirectly, one or more household devices 104 and a power meter 106. The household devices 104 comprise a refrigerator 108 and a washing machine 110, but could comprise any other household appliances, e.g., dishwasher, clothes dryer, stove, etc. The management system 100 may connect with a network system 1000, which has one or more external devices 1500 (e.g., an external server) coupled via a network 2000. FIG. 1 also depicts a plurality of computing devices 112 that can comprise a computer 114 and/or one or more mobile devices 116 (e.g., a PDA, smartphone, tablet computer, etc.). An end user can use the computing devices 112 to interface with the apparatus 102, e.g., via a graphical user interface.

The appliances 104 can communicate a variety of information to the apparatus 102. This information includes data that concerns operating characteristics (e.g., power consumption). As set forth below, the appliances 104 can also communicate information that relates to other functions and/or features (collectively, “appliance functions”), which may fall outside of the scope of the operating characteristics. For example, the appliances 104 can communicate information that identifies movement by an individual proximate the appliance 104 and/or identifies when access to the interior of the appliance 104 occurs. In one embodiment, the appliance 104 conveys this information to the apparatus 102 in the form of a first output that the apparatus 102 can receive and, in response, generate a second output that is sent to one or more of the computing devices 112.

The first output can comprise a data packet with information and/or data that instructs the apparatus 102 as to the nature of appliance and the appliance function. Information in the data packet can also indicate a status of the appliance function that may prompt the apparatus 102 to generate the second output. The data packet can encode this information using a variety of encoding schemes. Exemplary schemes can use numeric, alphabetic, and alphanumeric coding such as binary and ASCII coding. The present disclosure likewise considers more complex encoding, which can provide more secure communication of information about the management system 100 and the network system 1000. Details of the various encoding schemes are known by artisans having skill in the relevant appliance art, thus the present disclosure foregoes a detailed discussion herein.

An example of a data packet is shown in Table 1 and described below.

TABLE 1

| Appliance | Function | Status |
|---|---|---|
| Identifier | Identifier | Identifier |
| Refrigerator | Movement | Active |
| | Entry | Inactive |
| Washing machine | Movement | Disabled |
| | Entry | Disabled |
| | Water Pressure | Active |

Table 1 shows that the data packet can comprise an appliance identifier, a function identifier, and a function status. The appliance identifier comprises information that describes characteristics of the appliance 104. These characteristics may identify the appliance 102 by type, make, model, model number, and the like. In one embodiment, the apparatus 102 uses the appliance identifier to distinguish the appliances 104 in the household from one another. Examples of the appliance identifier can comprise a first appliance identifier, e.g., for the refrigerator 108, and a second identifier, e.g., for the washing machine 110.

The function identifier comprises information about the appliance functions. For example, if the appliance 104 can monitor movement, then the data packet will include a first function identifier associated with the movement (or proximity) function. Likewise if the appliance 104 can monitor ingress and egress into the interior of the appliance, then the data packet will include a second function identifier associated with the entry function. It is noted that the appliances 104 can incorporate any number and variety of appliance functions. The movement function and the entry function are but two examples of the possible features that that appliances 102 can comprise. Often the availability of the appliance functions may depend on characteristics of the appliance 102. For example, refrigerators may have appliance functions that are not found, or are not available, on washing machines. The present disclosure contemplates the vast array of appliances that may benefit from the subject matter disclosed herein as well as the wide variety of appliance functions that these appliances may incorporate.

In this connection, the data packet can comprise any number of function identifiers as desired. In one example, the data packet may comprise only function identifiers for appliance functions that are available on the appliance 102 (e.g., the refrigerator 108 and the washing machine 110). In another example, the data packet may comprise function identifiers for appliance functions that might be available for a given type of appliance 104 (e.g., a refrigerator, a washing machine, a stove, etc). Selection of the available appliance functions may occur at the manufacturing level, where different models include different appliance functions, or at the household level, where the end user can activate and deactivate different appliance functions as desired. In one example, the data packet may also comprise an indication that distinguishes the appliance functions that are available and/or enabled from those that are not available and/or disabled. The function identifiers permit discoverability of the appliance functions during installation of the appliance 104 and/or the apparatus 102. For example, when the apparatus 102 is positioned in the household, it exchanges information or “discovers” the appliances 104 within the household that are available and are able to communicate. In one implementation, the apparatus 102 uses the data packet, and more particularly the function identifiers, to determine the appliance functions that each of the appliances 104 support. Once the appliance functions are known, the apparatus 102 can communicate this information to another device (e.g., the power meter 106, the computing device 112, and the external server 1500).

The function status comprises information about the appliance function that can prompt the apparatus 102 to generate the second output. For example, function status may indicate a change in the status of the appliance function at any given time. In one illustrative example, when the appliance 104 detects motion, the function status associated with the movement function will comprise information that indicates movement. The function status may indicate that a sensor experiences a change in state (e.g., from inactive to active) or, in more sophisticated implementations, the function status may provide other relevant information, e.g., how close an object is to the appliance, chronological information (date and/or time) when the change of state occurred, and the like.

The apparatus 102 can process the information of the data packet and generate the second output in response thereto. Within the energy management system 100, the apparatus 102 operates as a central hub that receives data and information. Embodiments of the apparatus 102 can monitor and manage energy consumption, exchanging information with the appliances 102 and/or other devices (e.g., the power meter 106) and, in one example, generating various outputs (e.g., the second output). At a high level, the apparatus 102 operates as a data server for providing data to a client application running on a client device, which in turn can present the data to an end user, e.g., in the form of a graph, message, text message, and the like. In some configurations, the apparatus 102 can interface with the network system 1000 to receive and/or distribute information and data with the external servers 1500 and the computing devices 112 via the network 2000. The network system 1000 can store data on the external servers 1500 or other external storage devices and “cloud-based” computing networks. In one example, executable instructions (e.g., software and firmware) that encode or otherwise embody the various methods and algorithms to implement and generate the first output, the second output, and the data packets above can also reside external to the apparatus 102 and the appliance 104. Communication with the system 100 and the network 2000 can occur via wired and/or wireless communication using known and/or standard communication protocols (e.g., 802.11, etc.).

The computing devices 112 can provide a graphical user interface (GUI) or other display by which an end user can interface with the apparatus 102 and/or receive the second output therefrom. One or more of the mobile devices 116 may utilize a mobile application or application programming interface (API) that provides the end user with visual indications, representations, and other tools and features for exchanging information with the apparatus 102. For example, one or more of the computing devices 112 may provide an interface that permits the end user to enable, disable, activate, deactivate, or otherwise change settings that determine the content of the second output from the apparatus 102. In context of the appliance functions above, the GUI and/or interface can integrate these features to permit the end user to select the appliance functions for which alerts (e.g., the second output) will be sent. The end user can select, for example, to enable (or activate) the movement function, thereby instructing the apparatus 102 to include information in the second output that indicates when movement occurs. Likewise the end user can select to disable (or deactivate) the entry function, which instructs the apparatus 102 to disregard this appliance function and/or to prohibit the apparatus 102 from generating the second output when entry into the appliance 104 occurs.

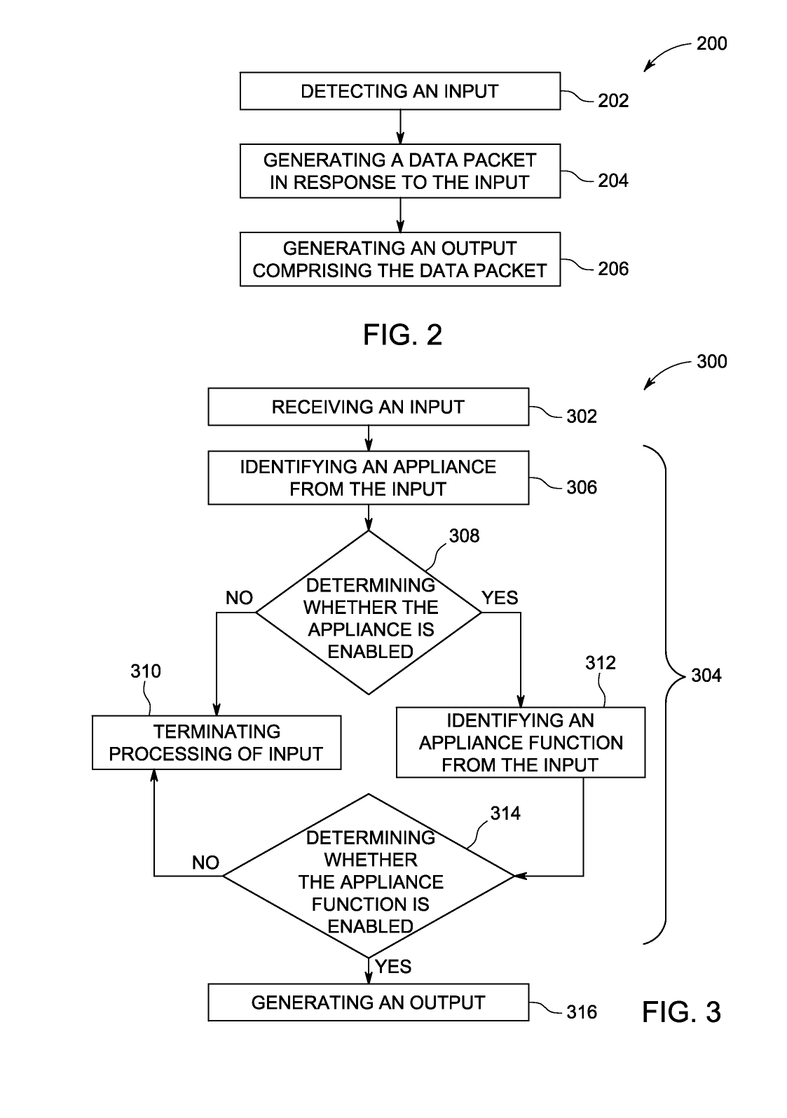

FIG. 2 depicts a flow diagram of a method 200 to generate an output on an appliance (e.g., the appliances 104 of FIG. 1). The method 200 comprises, at block 202, detecting an input and, at block 204, generating a data packet in response to the input. The method 200 also comprises, at block 206, generating an output comprising the data packet. As discussed above, the data packet can comprise an appliance identifier identifying the appliance, a function identifier identifying an appliance function that generates the input, and a function status indicating a change in status of the appliance function.

The input can arise from a variety of sources. These sources may be found in, around, and proximate the appliance. In one example, the appliance may incorporate one or more sensors such as proximity sensors, infrared sensors, ultrasonic sensors, temperature sensors, humidity sensors, voltage sensors, current sensors, and the like. These and/or other sensors may have specific appliance functions, e.g., controlling a temperature within an appliance, monitoring the position of a door of the appliance, determining whether a container is present below an ice chute or water dispenser, controlling energy usage during one or more predetermined time periods, etc. Collectively these sensors can generate a multiplicity of inputs that the appliance can use to monitor the status and/or operation of the appliance as well as to determine other data related to use of the appliance. For example, monitoring the position of the door of the appliance may indicate when access to the interior of the appliance occurs.

The appliance can generate the data packet by determining the appliance function that is associated with the input. A computer-readable memory coupled with the appliance may comprise, for example, a listing, look-up table, or other database that catalogs the various sensors and their corresponding inputs. Once a function identifier is created, it may be assigned a value indicative of function status. Again the appliance may utilize a look-up table or other aggregation of information that indicates a change in the appliance function. For example, the appliance may compare values in the input to corresponding default and/or stored values to identify the change in the appliance function. For example, for a proximity sensor, the appliance may look to compare the value of the input with a threshold value that indicates that movement has occurred. In another example, the appliance may look to compare the value of the input with a value that indicates the sensor is active and/or inactive such as in the case of a binary-type sensor with a high voltage level (“active”) and a low voltage level (“inactive”).

The output can comprise the data packet and/or a representation of the data packet from which the apparatus can discern the information stored therein. In addition to the data packet, the output can also comprise other information such as date and time stamps, security information, and other operating information. Moreover, although the discussion above describes the data packet in terms of the appliance identifier, function identifier, and function status, it is contemplated that the data packet can comprise other information as well. For example, the data packet and/or output may comprise temperature information to correlate power consumption data with certain times of day. For a refrigerator, the data packet and/or output may also comprise temperature information to correlate with the entry function to understand how long the doors of the appliance are open.

FIG. 3 depicts a flow diagram of a method 300 to generate an output on an apparatus (e.g., the apparatus 102 of FIG. 1). The method 300 comprises, at block 302, receiving an input and, identified generally by the numeral 304, determining an output in accordance with the input. In the present example, the method 300 also comprise, at block 306, identifying an appliance from the input and, at block 308, determining whether the appliance is enabled. The end use may, for example, select a certain appliance in the household from which to receive information. Such selection may occur via a graphical user interface that provides a selection of appliances (e.g., refrigerator, stove, etc.) and corresponding icons the use can select to enable the appliance If the appliance is not enabled, then the method 300 comprises, at block 310, terminating processing of the input. On the other hand, if the appliance is enabled, then the method 300 comprises, at block 312, identifying an appliance function from the input and, at block 314, determining whether the appliance function is enabled. If the appliance function is enabled, then the method 300 comprises, at block 316, generating the output. An end user can enable an appliance function, e.g., through a user interface on a computing device or other remote device. The appliance can also enable the appliance function automatically such as through executable instructions provided therein.

The output can convey information in a variety of ways. The output can comprise one or more electronic messages (e.g., an email message, text message, etc.) that the apparatus transmits and the computing devices receive. For display on a computer, laptop, tablet computer, or similar computing device, the output may comprise information that relates to both the change in status of the appliance, the appliance function, and/or other information, such as, but not limited to: information about power consumption, household energy use, and the like. For mobile applications (e.g., smartphones and/or tablet computers) the output can comprise both a text message and an audible alarm and/or an audible alert that indicates the change in status of the appliance and/or of the appliance function. It is contemplated that the end user can modify the information of the output through the user interface (e.g., the GUI) discussed above. The user interface enables the end user to select any number of features for the output including, for example, the device which is to generate the first output for a certain appliance function, the content of the message, the type of alert, the time of delivery (e.g., real-time and/or delayed), the type of delivery (e.g., electronic message and/or telephone call), among others.

As set forth in connection with the method 200 of FIG. 2 above, processing of the input may require the use of various look-up tables and databases that provide comparative information. The apparatus may, for example, process the input by comparing the appliance identifier to a table of values to determine the type of appliance from which the input originates. The apparatus may also compare the function identifier and/or the function status to a table of values to determine the type of appliance function and to identify the meaning of the function status, i.e., whether an alert should be broadcast, whether a reminder should be broadcast, and the like.

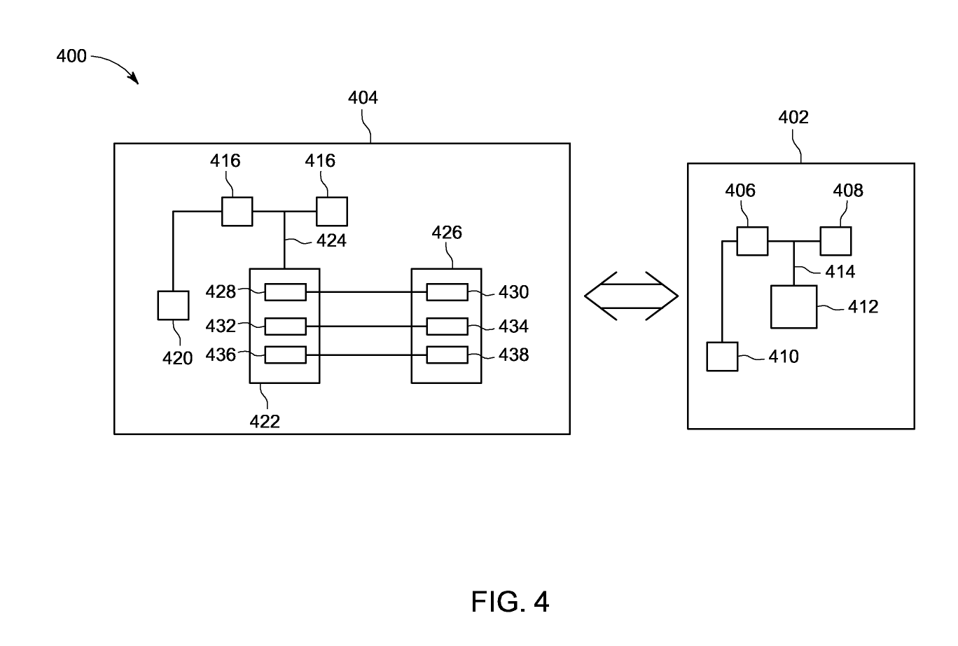

FIG. 4 illustrates a high-level wiring schematic of an energy management system 400 (e.g. the system 100 of FIG. 1). Generally a variety of configurations can implement the concepts of the present disclosure. The example of FIG. 4 provides a schematic diagram of one exemplary structure. In the present example, the system 400 comprises a remote apparatus 402 and an appliance 404. The remote apparatus 402 comprises a processor 406 and memory 408. The remote apparatus 402 also comprises one or more radios 410, control circuit 412, and busses 414. The appliance 404 comprises a processor 416, memory 418, one or more radios 420, and an appliance control circuit 422, all coupled together with busses 424. The appliance control circuit 422 may comprise one or more sensor circuits which connect to sensors 426. The sensor circuits may comprise a motion sensing circuit 428 coupled to a proximity sensor 430, an entry sensing circuit 432 coupled to a door sensor 434, and a temperature sensing circuit 436 coupled to one or more temperature sensors 438.

The remote apparatus 402 and the appliance 404 execute high-level logic functions, algorithms, as well as firmware and software instructions. Examples of these functions and algorithms are provided in connection with FIGS. 3 and 4 discussed above. The steps of the methods 200 and 300 can be provided as executable instructions, which the components of the appliance 402 and the remote apparatus 404 can execute to implement and, ultimately, generate the inputs and outputs disclosed herein.

In one example, the processors 406, 416 are a central processing unit (CPU) such as an ASIC and/or an FPGA. The processors 406, 416 can also include state machine circuitry or other suitable components capable of receiving inputs from the control circuit 412, 422 and/or directly from the sensors 426 and/or other components (e.g., the computing devices 112 of FIG. 1). The memory 408, 418 comprises volatile and non-volatile memory and can be used for storage of software (or firmware) instructions and configuration settings. In some embodiments, the processors 406, 416, the memory 408, 418, and the control circuit 412, 422 can be contained in a single integrated circuit (IC) or other component. As another example, the processors 406, 416 can include internal program memory such as RAM and/or ROM. Similarly, any one or more of functions of these components can be distributed across additional components (e.g., multiple processors or other components).

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose embodiments of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A appliance, comprising:
a control circuit comprising a processor and a memory;
one or more executable instructions stored on the memory and executed by the processor, the one or more executable instructions comprising instructions that when executed by the control circuit cause the control circuit to:
detect an input;
generate a data packet in response to the input, the data packet comprising an appliance identifier identifying said appliance, a function identifier identifying an appliance function that generates the input, and a function status indicating a change in status of the appliance function; and
generate an output comprising the data packet,
wherein the output indicates a change in the status of the appliance function.

2. The appliance of claim 1, further comprising a sensor coupled to the control circuit, wherein the sensor generates the input.

3. The appliance of claim 1, further comprising a proximity sensor, wherein the appliance function monitors movement proximate said appliance.

4. The appliance of claim 1, wherein the appliance function monitors a door on said appliance.

5. The appliance of claim 1, wherein the appliance identifier identifies said appliance by type.

6. The appliance of claim 1, further comprising assigning the function identifier and the function status in response to the input.

7. The appliance of claim 1, further comprising:
a radio coupled to the control circuit; and
an executable instruction for transmitting the output via the wireless radio.

8. A device for use in a home energy management system, comprising
a processor;
memory coupled to the processor; and
one or more executable instructions stored on the memory and are configured to be executed by the processor, the one or more executable instructions comprising instructions for:
receiving an input from an appliance, the input comprising a data packet comprising an appliance identifier identifying the appliance, a function identifier identifying an appliance function, and a function status indicating a status of the appliance function; and
determining an output in accordance with the data packet,
wherein the output indicates a change in the status of the appliance function.

9. The device of claim 8, further comprising instructions for identifying the appliance function as an enabled appliance function.

10. The device of claim 8, further comprising instructions for identifying the appliance as an enabled appliance.

11. The device of claim 10, further comprising instructions for identifying the appliance from among a plurality of appliance.

12. The device of claim 8, further comprising a wireless radio, wherein the instructions comprise instructions for transmitting the output via the wireless radio.

13. The device of claim 8, wherein the output can be read on a mobile device.

14. The device of claim 8, wherein the output comprises an electronic message.

15. The device of claim 8, wherein the output comprises an audible alert.

16. An appliance, comprising
a sensor;
a circuit coupled to the sensor, the circuit comprising a processor and memory coupled to the processor; and
one or more executable instructions that can be stored on the memory and are configured to be executed by the processor, the one or more executable instructions comprising instructions that when executed by the processor cause the processor to:
detect an input from the sensor;
generate a data packet in response to the input, the data packet comprising an appliance identifier identifying said appliance, a function identifier identifying an appliance function that generates the input, and a status identifier indicating a change in status of the appliance function; and
determine an output in accordance with the data packet,
wherein the output indicates a change in the status of the appliance function.

17. The appliance of claim 16, further comprising:
a radio coupled to the circuit; and
an executable instruction for transmitting the output via the radio.

18. The appliance of claim 16, wherein the input originates from outside of the appliance.

19. The appliance of claim 16, further comprising:
comparing the status identifier to a threshold value; and
generating the output if the identifier deviates from the threshold value.

20. The appliance of claim 16, further comprising broadcasting the output from said appliance.
